(19) United States
(12) Patent Application Publication
(10) Pub. No.: US 2026/0222064 A1
(43) Pub. Date: Jul. 30, 2026

(54) LIGHT-BASED DEVICE PAIRING

(71) Applicant: Apple Inc., Cupertino, CA (US)

(72) Inventors: Christopher J. VERPLAETSE, San Francisco, CA (US); Clark D. DELLA SILVA, Oakland, CA (US); Philip K. REYNERI, San Francisco, CA (US); Scott G. JOHNSTON, Los Gatos, CA (US); Patrick LIU, Cupertino, CA (US); Sharan JUANGPHANICH, Cupertino, CA (US)

(21) Appl. No.: 19/219,451

(22) Filed: May 27, 2025

Related U.S. Application Data
(60) Provisional application No. 63/751,054, filed on Jan. 29, 2025.

(51) Int. Cl. H04B 10/114; H04W 12/50

(52) U.S. Cl. CPC H04B 10/1141; H04W 12/50

(57) ABSTRACT

The present disclosure generally relates to pairing accessory devices. Some techniques are for establishing a secure communication channel in accordance with some embodiments.

### CROSS-REFERENCE TO RELATED APPLICATIONS

This application claims priority to U.S. Provisional Patent Application Ser. No. 63/751,054, entitled “LIGHT-BASED DEVICE PAIRING” filed Jan. 29, 2025, which is hereby incorporated by reference in its entirety for all purposes.

### BACKGROUND

Electronic devices are becoming increasingly interconnected. For example, accessory devices are often configured to form an ecosystem of accessory devices (e.g., speakers, fans, thermostats, and/or locks) within a home. Securely adding new accessory devices to an existing ecosystem has become more difficult as accessory devices become more feature rich and complicated. Accordingly, there is a need to improve techniques for pairing accessory devices.

### SUMMARY

Current techniques for pairing accessory devices are generally ineffective and/or inefficient. For example, some techniques for pairing a desired accessory device require users to manually enter configuration information or follow lengthy setup procedures using a different electronic device. This disclosure provides more effective and/or efficient techniques for pairing accessory devices using examples of a smartphone adding an accessory device to an ecosystem of accessory devices. It should be recognized that other types of electronic devices can be used with techniques described herein. For example, a laptop or desktop computer system with a camera (e.g., a built-in and/or external webcam) can pair a desktop accessory device (e.g., mouse, keyboard, and/or wireless display) using techniques described herein. In addition, techniques optionally complement or replace other techniques for pairing accessory devices.

Some techniques are described herein for establishing a secure communication channel between a device and an accessory device through a combination of an unsecure communication channel and a pattern of light. For example, a personal device can add an accessory device to a secure network (e.g., an ecosystem of accessory devices and/or a home network) through information encoded in light output by the accessory device.

In some embodiments, a method that is performed at a first computer system that is in communication with one or more input devices is described. In some embodiments, the method comprises: sending, via a first communication channel, a request for a second computer system to output light, wherein the second computer system is external to the first computer system; after sending the request for the second computer system to output light, detecting, via the one or more input devices, light corresponding to the second computer system; and in response to detecting the light corresponding to the second computer system: in accordance with a determination that the light has a first pattern of light, connecting, via a second communication channel separate from the first communication channel, to the second computer system using information encoded in the first pattern of light; and in accordance with a determination that the light has a second pattern of light, connecting, via the second communication channel, to the second computer system using information encoded in the second pattern of light.

In some embodiments, a non-transitory computer-readable storage medium storing one or more programs configured to be executed by one or more processors of a first computer system that is in communication with one or more input devices is described. In some embodiments, the one or more programs includes instructions for: sending, via a first communication channel, a request for a second computer system to output light, wherein the second computer system is external to the first computer system; after sending the request for the second computer system to output light, detecting, via the one or more input devices, light corresponding to the second computer system; and in response to detecting the light corresponding to the second computer system: in accordance with a determination that the light has a first pattern of light, connecting, via a second communication channel separate from the first communication channel, to the second computer system using information encoded in the first pattern of light; and in accordance with a determination that the light has a second pattern of light, connecting, via the second communication channel, to the second computer system using information encoded in the second pattern of light.

In some embodiments, a transitory computer-readable storage medium storing one or more programs configured to be executed by one or more processors of a first computer system that is in communication with one or more input devices is described. In some embodiments, the one or more programs includes instructions for: sending, via a first communication channel, a request for a second computer system to output light, wherein the second computer system is external to the first computer system; after sending the request for the second computer system to output light, detecting, via the one or more input devices, light corresponding to the second computer system; and in response to detecting the light corresponding to the second computer system: in accordance with a determination that the light has a first pattern of light, connecting, via a second communication channel separate from the first communication channel, to the second computer system using information encoded in the first pattern of light; and in accordance with a determination that the light has a second pattern of light, connecting, via the second communication channel, to the second computer system using information encoded in the second pattern of light.

In some embodiments, a first computer system configured to communicate with one or more input devices is described. In some embodiments, the first computer system comprises one or more processors and memory storing one or more programs configured to be executed by the one or more processors. In some embodiments, the one or more programs includes instructions for: sending, via a first communication channel, a request for a second computer system to output light, wherein the second computer system is external to the first computer system; after sending the request for the second computer system to output light, detecting, via the one or more input devices, light corresponding to the second computer system; and in response to detecting the light corresponding to the second computer system: in accordance with a determination that the light has a first pattern of light, connecting, via a second communication channel separate from the first communication channel, to the second computer system using information encoded in the first pattern of light; and in accordance with a determination that the light has a second pattern of light, connecting, via the second communication channel, to the second computer system using information encoded in the second pattern of light.

In some embodiments, a first computer system configured to communicate with one or more input devices is described. In some embodiments, the first computer system comprises means for performing each of the following steps: sending, via a first communication channel, a request for a second computer system to output light, wherein the second computer system is external to the first computer system; after sending the request for the second computer system to output light, detecting, via the one or more input devices, light corresponding to the second computer system; and in response to detecting the light corresponding to the second computer system: in accordance with a determination that the light has a first pattern of light, connecting, via a second communication channel separate from the first communication channel, to the second computer system using information encoded in the first pattern of light; and in accordance with a determination that the light has a second pattern of light, connecting, via the second communication channel, to the second computer system using information encoded in the second pattern of light.

In some embodiments, a computer program product is described. In some embodiments, the computer program product comprises one or more programs configured to be executed by one or more processors of a first computer system that is in communication with one or more input devices. In some embodiments, the one or more programs include instructions for: sending, via a first communication channel, a request for a second computer system to output light, wherein the second computer system is external to the first computer system; after sending the request for the second computer system to output light, detecting, via the one or more input devices, light corresponding to the second computer system; and in response to detecting the light corresponding to the second computer system: in accordance with a determination that the light has a first pattern of light, connecting, via a second communication channel separate from the first communication channel, to the second computer system using information encoded in the first pattern of light; and in accordance with a determination that the light has a second pattern of light, connecting, via the second communication channel, to the second computer system using information encoded in the second pattern of light.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIGS. 3A-3D illustrate exemplary user interfaces for adding an accessory device to an ecosystem in accordance with some embodiments.

FIG. 4 is a swim-lane diagram illustrating a process for establishing different communication channels in accordance with some embodiments.

FIG. 5 is a flow diagram illustrating a process for establishing a secure communication channel in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms unless explicitly stated with an order and/or that they are separate and/or different. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

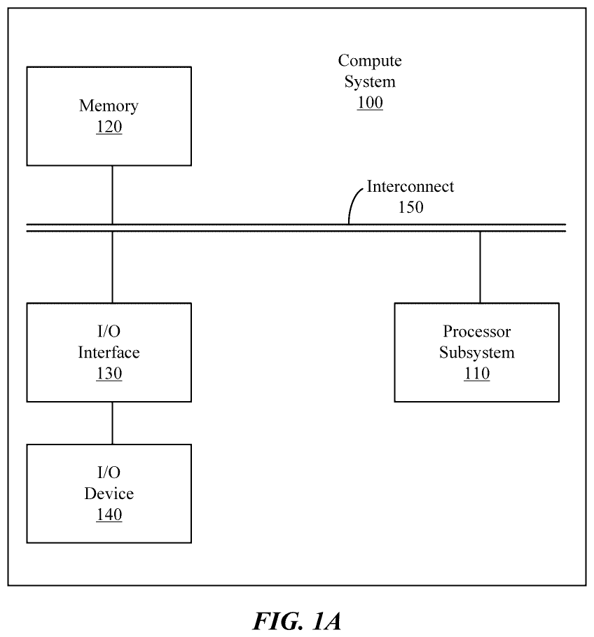

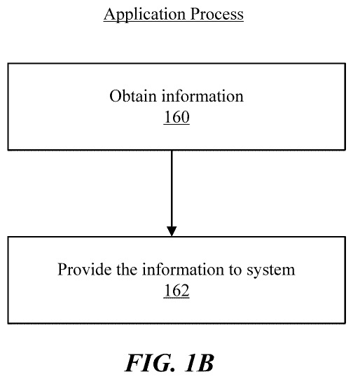

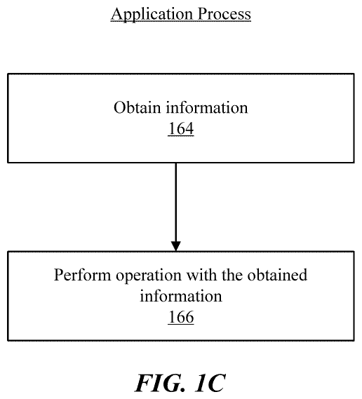

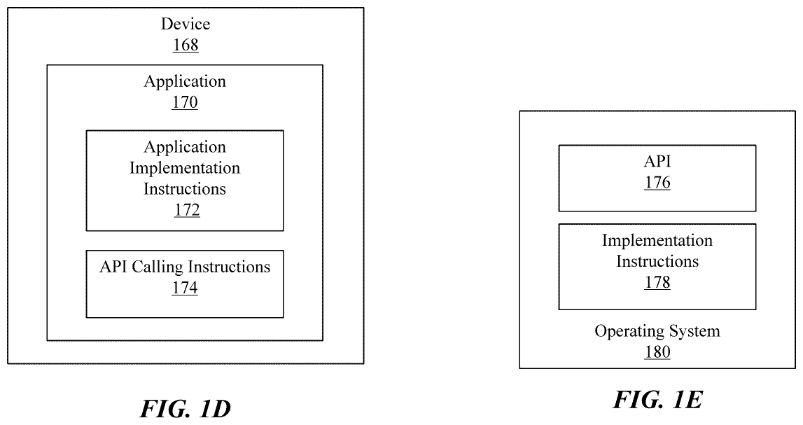

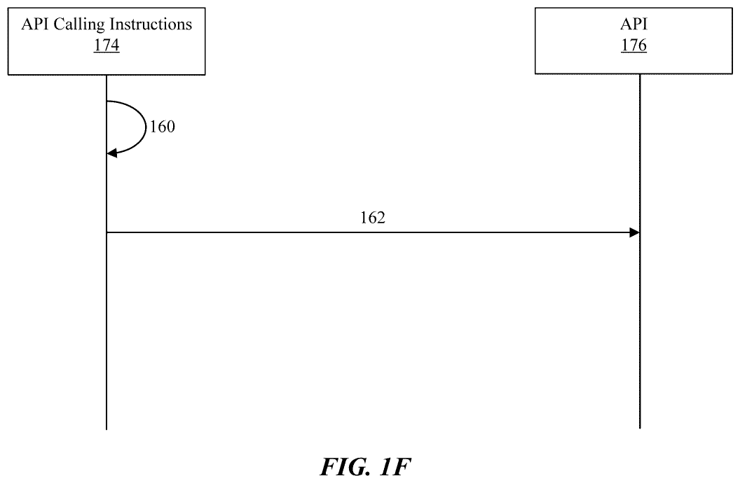

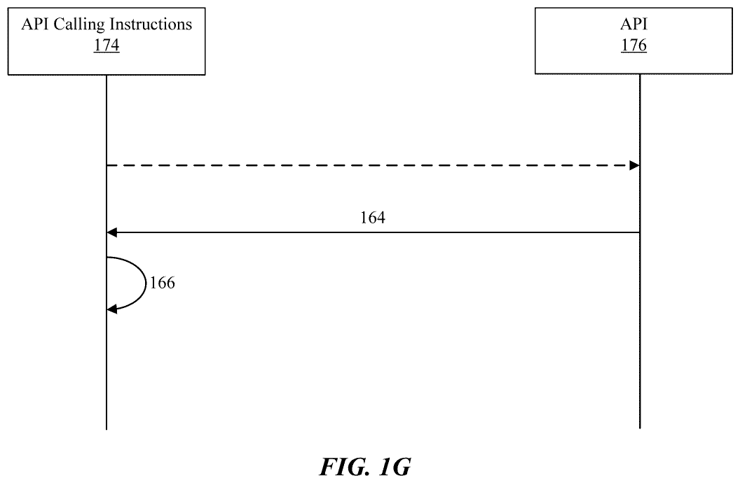

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

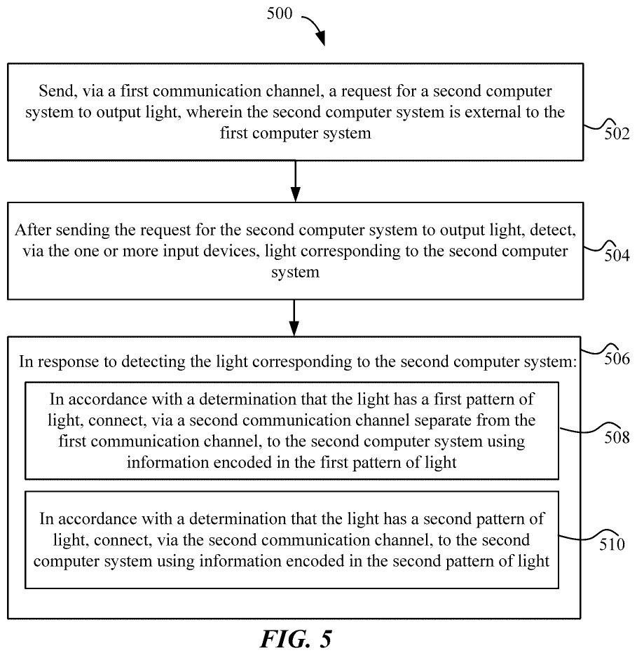

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with process 500 (FIG. 5) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

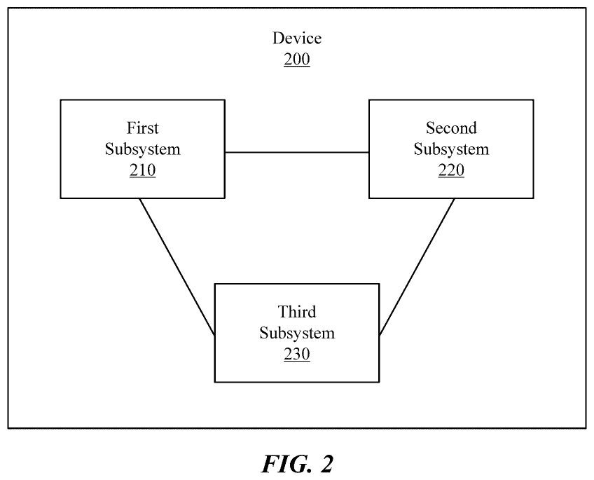

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for pairing accessory devices. Such techniques are described in the context of a smartphone adding an accessory device to an ecosystem of accessory devices. It should be recognized that other types of electronic devices can be used with techniques described herein. For example, a smartphone can connect with another smartphone using techniques described herein. In addition, techniques optionally complement or replace other techniques for pairing accessory devices.

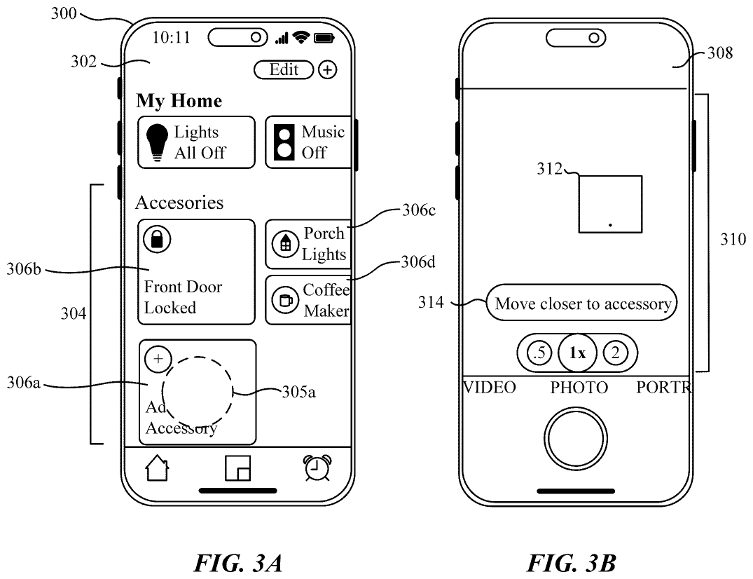

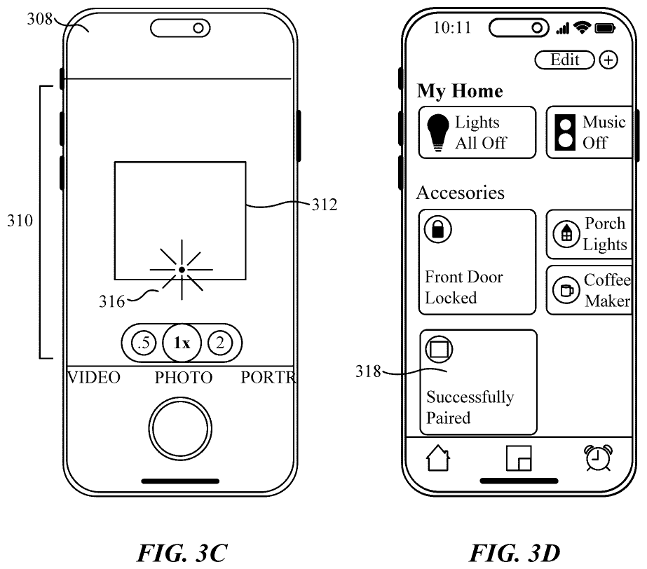

FIGS. 3A-3D illustrate exemplary user interfaces for adding an accessory device to an ecosystem in accordance with some embodiments. The user interfaces in these figures are used to illustrate the processes described below, including the processes in FIG. 5.

As illustrated in FIGS. 3A-3D, personal device 300 is a phone with a camera. It should be recognized that personal device 300 can be other types of computer systems, such as a laptop, a camera device, a desktop computer, a head-mounted display device, and/or a watch. In some embodiments, personal device 300 is a computer system that is associated with a particular user and/or one or more credentials corresponding to the particular user. For example, personal device 300 can be a phone that is linked to an account and/or a set of services of the particular user. In some embodiments, personal device 300 is associated with a network of devices and/or application for managing the network of devices. For example, personal device 300 can control and/or issue requests to one or more accessory devices through an accessory management application corresponding to the ecosystem, as discussed further below.

In some embodiments, accessory device 312 is a device that requires connection to another device (e.g., personal device 300 and/or a resident device) and/or service (e.g., the accessory management application) to provide functionality. For example, a camera accessory device can be required to be added to the accessory management application to provide additional functionality beyond local recording, such as remote playback, detection for recognition and/or security functionality, and/or remote storage.

In some embodiments, adding accessory device 312 to the ecosystem includes pairing accessory device 312 with personal device 300 and/or another computer system. In such embodiments, accessory device 312 can initiate pairing to personal device 300. For example, as discussed further below, the pairing can be started by accessory device 312 (e.g., an input on a button on accessory device 312), and personal device 300 can complete the pairing even though personal device 300 did not initiate the pairing.

In some embodiments, personal device 300 and/or accessory device 312 include and/or are in communication with one or more input devices. For example, personal device 300 can include and/or be in communication with a touch sensitive surface, a display, one or more cameras, and/or a light detecting sensor (e.g., photo diode, light detecting sensor, and/or a flicker sensor). For another example, accessory device 312 can include and/or be in communication with one or more cameras. In some embodiments, personal device 300 and/or accessory device 312 include and/or are in communication with one or more output devices. For example, personal device 300 can include one or more speakers. For another example, accessory device 312 can include a light emitting device (e.g., visible light emitting device and/or light emitting diode) and/or infrared (IR) light emitting device. As illustrated in FIGS. 3A-3D, personal device 300 includes a touch-sensitive display for guiding a user through pairing accessory device 312, as further discussed below. It should be recognized that while the following examples may reference particular components, such examples are for explanatory purposes only and the devices discussed further below can include additional and/or fewer components for alternative functionality and/or purposes. For example, accessory device 312 can lack a display and/or a set of speakers to reduce power draw and/or provide for a more energy efficient device.

In some embodiments, the ecosystem corresponding to the accessory management is a network of connected devices. In some embodiments, a wireless network (e.g., a Wi-Fi network) and/or a mesh network (e.g., a Thread network and/or peer network) provides devices within the ecosystem the ability to communicate. In some embodiments, the ecosystem provides secure communication between the devices within the ecosystem (e.g., as compared to alternative communication processes such as web-based controls). In some embodiments, devices added to the ecosystem communicate using a certain protocol (e.g., a secure communication protocol and/or an encrypted communication protocol). For example, devices within the ecosystem and/or devices associated with the ecosystem (e.g., personal device 300 and/or another device that is provided access through the accessory management application) can communicate with and/or control devices within the ecosystem. For another example, once accessory device 312 is added to the ecosystem, accessory device 312 cannot be added to another ecosystem and/or cannot be communicated with outside of the ecosystem. In some embodiments, the ecosystem includes management devices (e.g., routers, mesh nodes, and/or network switches), personal devices (e.g., personal device 300), and/or accessory devices (e.g., accessory device 312 and/or one or more other network connected devices). In some embodiments, as discussed below, the ecosystem enables personal device 300 control over accessory device 312 and/or another device within the ecosystem. For example, as illustrated in FIG. 3A, lock control 306b corresponds to a lock device that is connected to the ecosystem, enabling personal device 300 to unlock and lock a door associated with the lock device.

FIG. 3A illustrates personal device 300 displaying home management user interface 302. In some embodiments, home management user interface 302 is a user interface of the accessory management application mentioned above and can initiate actions to be carried out by one or more accessory devices that are part of the ecosystem. For example, the accessory management application can provide a dashboard associated with one or more cameras for viewing by a user. For another example, the accessory management application can provide a user a set of controls for triggering one or more actions to be carried out by connected accessory devices (e.g., turning on or off a set of lights and/or locking or unlocking a set of locks within a home). As further discussed below, new devices can be added to the ecosystem by personal device 300, enabling new and/or expanded functionality to be carried out by the new devices.

As illustrated in FIG. 3A, home management user interface 302 includes accessory section 304 with a set of controls for existing accessories (e.g., lock control 306b, porch lights control 306c, and coffee maker control 306d) and new accessory control 306a. In some embodiments, in response to detecting an input (e.g., a tap) on a control of the set of controls, personal device 300 sends, directly and/or via a network and/or a network of devices, a request to a corresponding accessory device to perform an action. For example, in response to detecting a tap input on lock control 306b, personal device 300 sends a request to unlock a front door. At FIG. 3A, new accessory control 306 is not associated with an existing device but initiates a process for adding a new accessory device to the ecosystem, as discussed further below. At FIG. 3A, personal device 300 detects input 305a directed to new accessory control 306. It should be recognized that input 305a is illustrated as a tap input though can be other types of inputs, such as a verbal input (e.g., a voice command such as “I want to add a new accessory”).

As illustrated in FIG. 3B, in response to detecting input 305a, personal device 300 displays camera user interface 308. In some embodiments, camera user interface 308 is a user interface of a separate application and/or an instance of a camera within the accessory management application. As illustrated in FIG. 3B, camera user interface 308 includes field of view 310, which is a of view of a currently active camera of personal device 300. As illustrated in FIG. 3B, accessory device 312 is at a first distance away from personal device 300 within field of view 310. At FIG. 3B, accessory device 312 is not outputting light, as discussed further below with respect to FIG. 3C. In some embodiments, accessory device 312 does not output light due to being too far away from personal device 300. For example, personal device 300 might be unable to request accessory device 312 to output light due to personal device 300 not being within close enough proximity to accessory device 312 to connect via a communication channel (e.g., a Bluetooth connection and/or proximity-based communication channel). For another example, accessory device 312 might not output light in response to detecting, via a camera of accessory device 312, that personal device 300 is too far away from accessory device 312 (e.g., accessory device 312 does not need to receive a request and can initiate light output based on a set of criteria being satisfied, such as personal device 300 being within a threshold distance from accessory device 312).

Further, due to the distance between accessory device 312 and personal device 300 (e.g., as illustrated by the size of accessory device 312 within camera field of view 310), personal device 300 displays indication 314, prompting movement of personal device 300 closer to accessory device 312. In some embodiments, personal device 300 displays indication 314 due to accessory device 312 not being close enough for personal device 300 to properly detect light (e.g., light 316 as described above with respect to FIG. 3C) output by accessory device 312. For example, personal device 300 can determine that accessory device 312 is too far away due to the relative size of accessory device 312 within field of view 310 to reliably detect light output by accessory device 312. In some embodiments, personal device 300 displays indication 314 due to failing to connect to accessory device 312 through a communication protocol. For example, accessory device 312 can be too far away from personal device 300 for personal device 300 to establish a Bluetooth connection. In some embodiments, personal device 300 continues to display indication 314 until accessory device 312 is within a certain proximity and/or is able to connect. After FIG. 3B, while continuing to display camera user interface 308, personal device 300 is moved closer to accessory device 312.

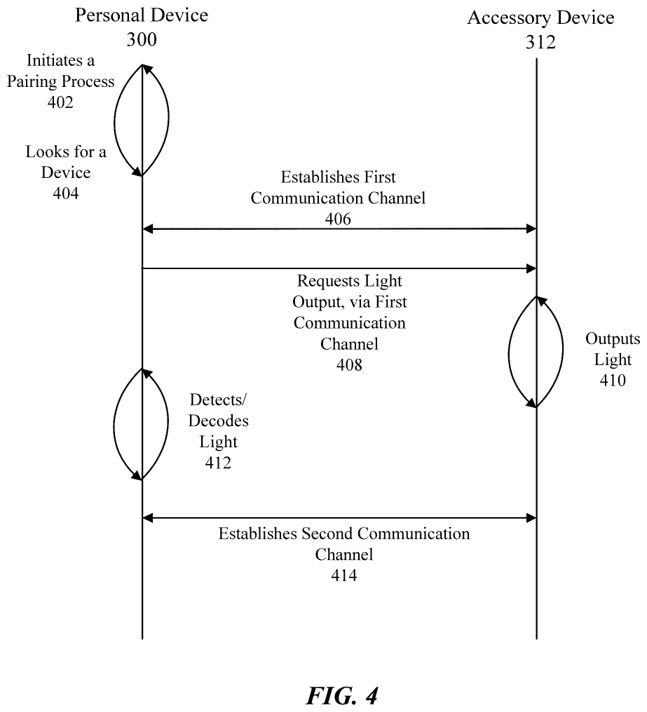

In some embodiments, due to moving closer to accessory device 312, personal device 300 is able to establish a communication channel with accessory device 312, as discussed further below with respect to FIG. 4. For example, accessory device 312 initiates an open Bluetooth connection in response to powering on for the first time, and once close enough, personal device 300 can connect to the Bluetooth connection. In some embodiments, the initial communication channel is an unsecure communication channel. For example, any device within a certain proximity can connect to accessory device 312.

As discussed further below with respect to FIG. 4, after establishing the initial communication channel, personal device 300 requests, via the initial communication channel, that accessory device 312 output light (e.g., light 316 as illustrated in FIG. 3C). In some embodiments, personal device 300 requests the light output in order to establish a secure communication channel, as discussed further below. For example, personal device 300 utilizes the light (e.g., light 316) output to receive information for adding accessory device 312 to a network of devices (e.g., a Thread network and/or a Wi-Fi network with one or more other accessory devices). In some embodiments, in response to requesting accessory device 312 output light, personal device 300 disconnects from the initial communication channel. In other embodiments, in response to receiving the request to output light, accessory device 312 terminates the initial communication channel.

As illustrated in FIG. 3C, after moving closer to accessory device 312 (e.g., as illustrated by the increase in size of accessory device 312 within field of view 310), accessory device 312 begins to output light 316. In some embodiments, light 316 is visible light that is output by a light emitting component of accessory device 312. In other embodiments, light 316 is infrared (IR) light that is output via an IR emitter of accessory device 312. In some embodiments, light 316 is an intermittent output of light. For example, light 316 can include a pattern of light corresponding to information encoded within light 316 as discussed further below with respect to FIG. 4. In such an example, accessory device 312 pulses light 316 at a certain frequency to encode information for establishing a secure communication channel, as discussed further below.

In some embodiments, accessory device 312 outputs different types of light depending on different situations. For example, accessory device 312 utilizes IR light in response to receiving a request to output light when a room that accessory device 312 is within is dark (e.g., utilizes IR light to not increase a light level of a room and/or to not distract a person within the room). For another example, accessory device 312 can utilize IR light when a room is too bright for personal device 300 to differentiate between light output by accessory device 312 and other light sources.

At FIG. 3C, while accessory device 312 outputs light 316, personal device 300 detects light 316. In some embodiments, light 316 is detected via the currently active camera providing field of view 310. In other embodiments, light 316 is detected via a sensor separate from the currently active camera providing field of view 310. For example, personal device 300 can use a flicker sensor (e.g., a photo diode and/or light reactive sensor) for detecting light 316. In some embodiments, light 316 includes encoded information for establishing a secure communication channel between personal device 300 and accessory device 312 (e.g., through Wi-Fi or Thread). In some embodiments, along with detecting light 316, personal device 300 receives information from accessory device 312 through the first communication channel, as mentioned above. For example, personal device 300 can receive a confirmation of accessory device 312 outputting light 316 and/or a nonce value for combining with the encoded information.

At FIG. 3C, while (and/or after) detecting light 316, personal device 300 decodes information within light 316. In some embodiments, personal device 300 decodes the information within light 316 to establish a secure communication channel with accessory device 312 for facilitating remaining steps for the pairing. In some embodiments, accessory device 312 sends personal device 300 identifying information, authentication information, device capabilities, and/or communication capabilities via the secure communication channel to finalize adding accessory device 312 to the ecosystem. For example, accessory device 312 can provide the identifying information (e.g., a name, an IP address, a MAC address, and/or a unique identifier) to personal device 300 to allow one or more other devices within the ecosystem to communicate with accessory device 312 through the secure communication channel. For another example, accessory device 312 can provide the authentication information to personal device 300 to allow personal device 300 to confirm that accessory device 312 is a trustworthy device and/or that accessory device 312 can be trusted to connect to the ecosystem. For another example, accessory device 312 can provide the device capabilities to personal device 300 to allow personal device 300 to display a correct set of controls within a user interface of the accessory management application. For another example, accessory device 312 can provide the communication capabilities to personal device 300 to allow personal device 300 to designate what communication type to utilize with the ecosystem of devices. In some embodiments, the secure communication channel is used by personal device 300 to add accessory device 312 to a network of devices. For example, in response to decoding the information within light 316, personal device 300 uses the information to add accessory device 312 to a home network (e.g., a Wi-Fi network) and/or a network of devices (e.g., a Thread network and/or mesh network).

In some embodiments, additional user interfaces are provided between FIGS. 3C and 3D. Such additional user interfaces can include prompts and/or decisions to be made by a user to finalize setup of accessory device 312. In such embodiments, personal device 300 can provide one or more options and/or settings to apply to accessory device 312 upon registering accessory device 312 to a home ecosystem of devices associated with the home management application. For example, personal device 300 can assign an identification, a unique identifier, a location, and/or a grouping with other devices to accessory device 312. For another example, accessory device 312 can be added to an existing automation and/or one or more new automations.

As illustrated in FIG. 3D, after detecting and decoding the information within light 316, personal device 300 adds new accessory control 318 for accessory device 312 to home management user interface 302. In some embodiments, new accessory control 318 allows for operations to be performed with respect to accessory device 312, such as controlling operation of accessory device 312 and/or displaying one or more additional user interfaces corresponding to accessory device 312. For example, in response to detecting a tap input on new accessory control 318, personal device 300 displays a dashboard that includes additional information about accessory device 312 (e.g., battery life, connection status, and/or required update) and/or a set of controls for accessory device 312 (e.g., restart device, sleep and/or wake device, and/or assign device to a group of devices and/or zone within a home).

FIG. 4 is a swim-lane diagram that illustrates a process for establishing different communication channels in accordance with some embodiments. The flow diagram in this figure is used to illustrate the processes described below, including the processes in FIG. 5.

As illustrated in FIG. 4, process 400 begins with personal device 300 initiating (402) a pairing process. In some embodiments, the pairing process is initiated in response to personal device 300 detecting an input to initiate the pairing process, such as described above with respect to input 305a. In some embodiments, in response to personal device 300 initiating the pairing process, accessory device 312 enables a connection for pairing. For example, as part of initiating the pairing process, personal device 300 notifies devices within a certain proximity of an available pairing session.

It should be recognized that the pairing process can be initiated in other ways, such as a voice request and/or while a camera view of personal device 300 is being displayed. For example, personal device 300 and accessory device 312 can detect a voice request to pair accessory device 312 and, in response, personal device 300 and accessory device 312 can initiate a pairing session through mutual communication. For another example, while personal device 300 displays a field of view of an active camera outside of the accessory management application, personal device 300 can detect accessory device 312 within the field of view (e.g., recognizing a code and/or identifier on accessory device 312 that allows personal device 300 to know that accessory device 312 is not within the ecosystem).

In some embodiments, as discussed further below with respect to 410, accessory device 312 initiates the pairing process. For example, accessory device 312 can initiate the pairing process by enabling a connection upon starting up and/or powering on when accessory device 312 is not already paired with an ecosystem (e.g., as described above with respect to FIG. 3A). For another example, accessory device 312 can initiate the pairing process in response to detecting an input directed to a setup and/or pairing hardware control (e.g., touch sensitive button and/or physical button). In some embodiments, after accessory device 312 initiates the pairing process, accessory device 312 waits for personal device 300 to connect to accessory device 312 to facilitate one or more remaining steps to add accessory device 312 to the ecosystem, as discussed above.

After initiating a pairing session, personal device 300 begins looking (404) for a device ready to be paired (e.g., as described above with respect to FIGS. 3B-3C). In some embodiments, if personal device 300 is initially too far from a device ready for pairing, personal device 300 outputs (e.g., visually and/or audibly) a prompt to move closer to a desired accessory (e.g., as described above with respect to FIG. 3B). In some embodiments, personal device 300 looking for another device includes personal device 300 searching for open and/or unsecure pairing communication channels. For example, when powered on, accessory device 312 enables an unsecure communication channel for setup and/or pairing, and personal device 300 looking for a device includes waiting until a setup communication channel is found (e.g., until personal device 300 is brought within a certain proximity of an accessory device to connect to a communication channel). In some embodiments, personal device 300 looks for another device for a threshold amount of time and, if personal device 300 cannot find another device, personal device 300 ends a pairing process. In some embodiments, personal device 300 continues looking for another device until found and/or until process 400 is ended. In some embodiments, looking for another device includes personal device 300 detecting an accessory device in a field of view of one or more cameras, as discussed above with respect to FIGS. 3B-3C. For example, personal device 300 and accessory device 312 can be within a close enough distance to enable unsecure communication but not for detecting light (e.g., accessory device 312 does not fill enough of personal device 300's camera field of view, as discussed above with respect to FIG. 3B), and personal device 300 prompts to move closer to accessory device 312.

After finding another device ready to be paired (e.g., accessory device 312), personal device 300 establishes (406) a first communication channel with the other device (e.g., accessory device 312). In some embodiments, the first communication channel is a temporary communication channel. For example, personal device 300 terminates the first communication channel after sending a request and/or certain information. In some embodiments, the first communication channel is an unsecure communication channel, such as an open Bluetooth connection that personal device 300 can connect to without any credential and/or authentication. In some embodiments, the unsecure communication channel is a proximity-based communication channel providing nearby devices a communication channel for discovering and/or pairing with accessory device 312. For example, accessory device 312 initiates an open communication channel to facilitate setup (e.g., via another device and/or personal device 300) in response to powering on.

After establishing the first communication channel, personal device 300 sends (408) a request for accessory device 312 to output light (e.g., light 316 as described above with respect to FIG. 3C). In some embodiments, after personal device 300 sends the request, the first communication channel is terminated. For example, accessory device 312 disables the first communication channel in response to receiving the request to output light. In some embodiments, after sending the request for accessory device 312 to output light, personal device 300 disconnects from the first communication channel.

In some embodiments, the request is a general request for setup information. For example, personal device 300 requests that accessory device 312 send certain information through one or more available means, such as a pattern of light. However, it should be recognized that light output is only one modality of sending information between local devices (e.g., outside of communication channels such as Bluetooth, Wi-Fi, and/or Thread) and one or more modalities can be used alongside or instead of the light output. For example, accessory device 312 can output an audio tone that includes similar information as discussed below with respect to the information encoded in the pattern of light (e.g., the audio tone is a series of tones and/or a tone of a certain frequency that encodes setup information).

After receiving the request to output light, accessory device 312 begins outputting (410) light (e.g., as described above with respect to FIG. 3C). In some embodiments, accessory device 312 outputs visible light via a light emitting diode (LED). In some embodiments, accessory device 312 outputs infrared (IR) light via an IR emitter. In some embodiments, the light outputted by accessory device 312 depends on context of an environment. For example, in response to determining that it is nighttime and/or dark, accessory device 312 outputs IR light to avoid distracting a subject within the environment and/or strobing a light source within a dark room. For another example, in response to determining that there are other devices emitting IR, accessory device 312 outputs visible light to avoid interference from other nearby devices.

In some embodiments, the light output by accessory device 312 is a pattern of light, an intermittent output of light, and/or pulses of light. For example, accessory device 312 pulses light at a frequency to encode information, as discussed below. In some embodiments, accessory device 312 outputs the pattern of light at a predefined rate due to hardware capabilities (e.g., minimum and maximum output frequencies of LEDs and/or IR emitters of accessory device 312 and/or minimum and maximum detection rates of cameras and/or light detection sensors of personal device 300), communication protocols (e.g., to avoid other communication protocols that utilize IR such as Pulse distance encoding for televisions and/or other accessory devices), and/or external factors (e.g., health concerns from pulsing light such as epilepsy and/or detectability of certain frequencies due to other light sources). In some embodiments, upon outputting light, accessory device 312 terminates the first communication channel. In some embodiments, accessory device 312 continues outputting light until a second communication channel is established. For example, accessory device 312 continues to output a pattern of light repeatedly (e.g., on loop) until a secure communication is received from personal device 300.

In some embodiments, accessory device 312 does not output light until a request is received. For example, process 400 can be initiated by a personal device (e.g., personal device 300), and accessory device 312 waits for a request to initiate process 400. As mentioned above, accessory device 312 can enable a communication channel in response powering on and/or an input on accessory device 312, and only output light in response to a request received through the communication channel. For example, accessory device 312 does not output light until a device (e.g., personal device 300) connects to accessory device 312.

In some embodiments, process 400 starts at 410 (e.g., skipping 402 through 408). For example, accessory device 312 begins outputting light in response to powering on and/or an input on accessory device 312 (e.g., an input on a hardware control and/or button). In some embodiments, due to process 400 starting at 410, accessory device 312 facilitates the output of light (e.g., when to output light and/or what light to use). For example, in response to powering on, accessory device 312 waits until another device (e.g., personal device 300) is detected within a field of view of a camera of accessory device 312 (e.g., waiting to output light until personal device 300 is within a certain proximity and/or fills a certain portion of the field of view). In some embodiments, due to process 400 starting at 410, personal device 300 is unaware of the light output of accessory device 312 until personal device 300 detects the light output. For example, a person must open a camera application and/or home management application, as discussed above with respect to FIGS. 3A-3D, and position accessory device 312 within a setup screen and/or camera field of view (e.g., facilitating pairing without a first communication channel). In some embodiments, personal device 300 can pick up the light output regardless of setup process. For example, personal device 300 attempts to decode patterns of light to enable pairing of accessory devices without requiring initiation of a pairing session from a home management application and/or accessory management application.

After sending the request for accessory device 312 to output light, personal device 300 begins trying (412) to detect a pattern of light within the light output by accessory device 312. In some embodiments, personal device 300 detects visible light output by accessory device 312 through one or more cameras. In some embodiments, personal device 300 alters the frame rate of one or more cameras to match the light output. For example, personal device 300 adjusts the frame rate of a camera to be within frequency and/or phase with the light output by accessory device 312. In some embodiments, personal device 300 detects visible light output by accessory device 312 through one or more sensors other than a camera. For example, personal device 300 can detect the light via a flicker sensor (e.g., a light detecting sensor that detects changes in light and/or that detects frequencies of light). In some embodiments, personal device 300 detects infrared (IR) light output by accessory device 312 through one or more sensors. In some embodiments, personal device 300 disconnects from the first communication channel in response to detecting the light output by accessory device 312. For example, personal device 300 disconnects from the first communication channel in response to determining that personal device 300's request for light output was received and/or is being carried out.

While (and/or after) detecting light output by accessory device 312, personal device 300 decodes information encoded within the light output. In some embodiments, personal device 300 decodes the information by mapping values to the frequency and/or pattern of light output by accessory device 312. For example, personal device 300 decodes an eight-bit binary signal from the light output by accessory device 312. In some embodiments, the information within the light output is limited information. For example, accessory device 312 only encodes an authorization code (e.g., accessory code for a particular ecosystem and/or protocol) within the light output (e.g., waiting to transfer remaining information and/or private information once connected via a secure communication channel). In some embodiments, the information within the light output includes generalized information. For example, accessory device 312 includes device-based information such as an identifier for accessory device 312, communication capabilities of accessory device 312 (e.g., for deciding what secure communication channel to use), and/or other non-private information (e.g., information from one or more sensors of accessory device 312 and/or general environmental information such as date, time, and/or location). In some embodiments, in response to failing to decode the information within the light output and/or to a determination that the information with the light output is incorrect and/or contains errors, personal device 300 sends a second request for light output (e.g., process 400 restarts at 408 and/or 410).

After detecting and decoding the light output by accessory device 312, personal device 300 establishes (414) a second communication channel with accessory device 312. In some embodiments, the second communication channel is a secure communication channel. For example, the second communication channel can be a home network, a WiFi network, a secure Bluetooth network, a Thread network, and/or a network of accessory devices. In some embodiments, the secure communication channel is an encrypted and/or private communication channel that utilizes a communication protocol for accessory devices. For example, the secure communication channel can be a network of accessory devices that communicate through a communication protocol to not impede general wireless communication and/or to improve connectivity between accessory devices. In some embodiments, accessory device 312 is added to the second communication channel and/or the second communication channel is established through the information encoded in the light output by accessory device 312. For example, personal device 300 verifies that the information encoded in the light output by accessory device 312 is correct, such that accessory device 312 is not a threat (e.g., accessory device 312 is a genuine accessory device and/or not a malicious device) and/or that accessory device 312 is compatible with a network of devices facilitated by the second communication channel (e.g., compatible with a certain accessory device communication protocol and/or management application).

In some embodiments, through communicating via the second communication channel, personal device 300 adds accessory device 312 to a network of accessory devices and/or an accessory management application for managing the network of devices. In some embodiments, the second communication channel remains for communication between personal device 300 and accessory device 312. In some embodiments, upon establishing the second communication channel, accessory device 312 terminates the first communication channel. In some embodiments, as discussed with respect to FIG. 3D, establishing the second communication channel allows personal device 300 additional functionality associated with accessory device 312. For example, personal device 300 can assign accessory device 312 to a certain zone, location, and/or group of devices. For another example, personal device can include accessory device 312 within an automation and/or create a new automation for accessory device 312 to carry out, as discussed above with respect to FIG. 3D.

FIG. 5 is a flow diagram illustrating a process (e.g., process 500) for establishing a secure communication channel in accordance with some embodiments. Some operations in process 500 are, optionally, combined, the orders of some operations are, optionally, changed, and some operations are, optionally, omitted.

As described below, process 500 provides an intuitive way for establishing a secure communication channel. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a first computer system (e.g., 300) that is in communication with (and/or includes) one or more input devices (e.g., as discussed above with respect to FIGS. 3A and 4) (e.g., a camera, light sensor, infrared sensor, infrared receiver, flicker sensor, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the first computer system is a watch, a phone, a tablet, a fitness tracking device, a processor, a head-mounted display (HMD) device, a communal device, a media device, a speaker, a television, an electronic device, and/or a personal computing device.

The first computer system sends (502), via a first communication channel (e.g., 406) (e.g., an initial communication channel, an unsecure communication channel, a temporary communication channel, and/or a Bluetooth communication channel), a request (e.g., 408) for a second computer system (e.g., 312) to output light (e.g., 316 and 410) (and/or causes the second computer system to output light), wherein the second computer system is external to (e.g., separate and/or different from) the first computer system (e.g., as discussed above with respect to FIG. 3B). In some embodiments, the second computer system is a watch, a phone, a tablet, a fitness tracking device, a processor, a head-mounted display (HMD) device, a communal device, a media device, a speaker, a television, an electronic device, and/or a personal computing device. In some embodiments, the first computer system and the second computer system are connected by the first communication channel due to proximity (e.g., the first computer system is brought within and/or begins listening for communication requests within a proximity to the second computer system) and/or by a connection protocol initiated by the first computer system and/or the second computer system (e.g., the first computer system and/or the second computer system initiate an unsecure pairing protocol and/or initiate a unsecure setup protocol). In some embodiments, the second computer system is in communication with (and/or includes) one or more output devices (e.g., a light emitting device, an infrared emitting device, and/or a light output device). In some embodiments, after sending the request to the second computer system to output light, the first computer system disconnects from the second computer system and/or terminates the first communication channel.

After sending the request for the second computer system to output light (and/or in conjunction with (e.g., while or after) the second computer system outputting light), the first computer system detects (504), via the one or more input devices, light (e.g., 316 and 412) (e.g., a pattern of light at a particular frequency, a series of light pulses containing data and/or information, a light pattern including data and/or information, and/or an infrared signal) corresponding to the second computer system (e.g., as discussed above with respect to FIGS. 3B and 4). In some embodiments, detecting the light corresponding to the second computer system includes detecting a series of values and/or data contained and/or encoded in the light corresponding to the second computer system. In some embodiments, the second computer system outputs the light at a particular rate and/or frequency to avoid interruption by other light outputs (e.g., infrared repeaters, wireless remotes, and/or other computer systems) and/or to avoid concerns corresponding to a subject (e.g., health concerns from strobing and/or pulsing light).

In response to (506) detecting the light corresponding to the second computer system, in accordance with a determination that the light has a first pattern of light (e.g., as discussed above with respect to 412 in FIG. 4), the first computer system connects (508), via a second communication channel (e.g., as discussed above with respect to 414 in FIG. 4) (e.g., a trusted communication channel, a key protected communication channel, a secure communication channel, and/or a network based communication channel such as Wi-Fi network, mesh network, and/or Thread network) separate from the first communication channel, to the second computer system using information encoded in the first pattern of light (e.g., as discussed above with respect to 412 in FIG. 4). In some embodiments, the information includes a secure key, an authentication code, and/or information needed for connecting via a secure communication channel. In some embodiments, the first computer system has an expected value and/or series of values, and the information includes and/or matches the expected value and/or series of values. In some embodiments, the first computer system connecting to the second computer system includes a direct connection (e.g., encrypted and/or secure tunnel communication) and/or network-based connection (e.g., adding the second computer system to a wireless network accessible and/or manageable by the first computer system).

In response to (506) detecting the light corresponding to the second computer system, in accordance with a determination that the light has a second pattern of light (e.g., as discussed above with respect to 412 in FIG. 4), the first computer system connects (510), via the second communication channel, to the second computer system using information encoded in the second pattern of light (e.g., as discussed above with respect to 412 in FIG. 4) (e.g., without using the information encoded in the first pattern of light). In some embodiments, the first computer system detects the light while connected via the first communication channel, and the first computer system terminates the first communication channel in conjunction with connecting, via the second communication channel, to the second computer system.

In some embodiments, the first communication channel is an unsecure communication channel (e.g., as discussed above with respect to 406 in FIG. 4) (e.g., a temporary communication channel and/or proximity-based communication channel). In some embodiments, the second communication channel is a secure communication channel (e.g., as discussed above with respect to 414 in FIG. 4) (e.g., an authenticated communication channel and/or network-based communication channel). In some embodiments, the unsecure communication channel allows any device within a certain proximity to connect to and/or communicate with the second computer system. In some embodiments, the unsecure communication channel is a communication channel that does not require a password, key phrase, authentication token, and/or account to connect to and/or communicate through the communication channel. In some embodiments, the secure communication channel is a network of devices (e.g., a home network that includes a set of other accessory devices and/or network management devices). In some embodiments, the secure communication channel is a Thread network (e.g., a device-based network and/or peer to peer communication network). In some embodiments, the secure communication channel is a limited communication channel (e.g., allowing certain types of information, allowing information of a certain protocol, and/or limiting communications to certain known devices). In some embodiments, the secure communication channel is a communication channel that requires authentication to connect to and/or communicate through the communication channel (e.g., a binary code, code from a connection protocol, password, key phrase, and/or authentication token).

In some embodiments, the unsecure communication channel is a Bluetooth connection (e.g., as discussed above with respect to 406 in FIG. 4). In some embodiments, the secure communication channel is a Wi-Fi connection or a Thread connection (e.g., as discussed above with respect to 414 in FIG. 4). In some embodiments, the Bluetooth connection is a communication channel that broadcasts information to nearby devices within a certain proximity without requiring prior pairing. In some embodiments, the secure communication channel is facilitated through communication across a network of connected devices. In some embodiments, the Wi-Fi connection is a brokered network of devices that requires a network management device and/or a router to transmit information between different devices. In some embodiments, the Thread connection is a mesh network of devices that relays information between connected devices until the information is received by its intended recipient. In some embodiments, the Wi-Fi connection utilizes a mesh of connected devices, and the mesh of connected devices self-manages passing information and/or relies on a mesh controlling device (e.g., the first computer system and/or another computer system). In some embodiments, the Wi-Fi connection and the Thread connection are separate networks of devices, but the first computer system utilizes the Wi-Fi connection and the Thread connection to communicate with the second computer system (e.g., depending on information and/or required functionality).

In some embodiments, after (and/or as a response to) sending the request for the second computer system to output light, the first computer system disconnects (e.g., as discussed above with respect to 408 in FIG. 4), via the first communication channel, from the second computer system without detecting, via the one or more input devices, an input corresponding to a request to disconnect from the first communication channel (e.g., as discussed above with respect to 408 in FIG. 4). In some embodiments, disconnecting, via the first communication channel, from the second computer system includes terminating the first communication channel. In some embodiments, the input corresponding to the request to disconnect from the first communication channel is an input to cancel a pairing process, to end a setup process, and/or to exit an application corresponding to the process.

In some embodiments, in response to connecting, via the second communication channel, to the second computer system using information encoded in the first pattern of light, the first computer system disconnects, via the first communication channel, from the second computer system (e.g., as discussed above with respect to 414 in FIG. 4) (e.g., without detecting, via the one or more input devices, an input corresponding to a request to disconnect from the first communication channel). In some embodiments, the first computer system and the second computer system are not connected via both the first communication channel and the second communication channel at any time. In some embodiments, the information sent and/or received between the first communication channel and/or the second communication channel is separate and/or formatted as to not be cross compatible between the different communication channels (e.g., different protocols and/or different security levels and/or encryption).

In some embodiments, the light is infrared light (e.g., as discussed above with respect to 410 in FIG. 4). In some embodiments, the second computer system includes an infrared (IR) emitter, and the second computer system outputs infrared light via the infrared emitter.

In some embodiments, the light is visible light (e.g., as discussed above with respect to 410 in FIG. 4). In some embodiments, the second computer system includes a light emitter (e.g., a light emitting diode), and the second computer system outputs the visible light via the light emitter.

In some embodiments, detecting the light corresponding to the second computer system includes detecting, via the one or more input devices, an intermittent output of light (e.g., 316 and/or as discussed above with respect to 410 and 412 in FIG. 4) (e.g., a series of light outputs and/or a series of light pulses) corresponding to (e.g., emitted by and/oy sent by) the second computer system. In some embodiments, the first pattern of light is identified in (and/or using, via, as encoded within) the intermittent output of light. In some embodiments, the intermittent output of light is a series of light pulses at a predetermined frequency. In some embodiments, the predetermined frequency is due to output device capabilities and/or receiving device capabilities and/or sensor modalities (e.g., detection rates of certain receivers and/or rate providing detection of separations in light output). In some embodiments, the predetermined frequency is rate limited to prevent adverse effects of light pulsing (e.g., health concerns of strobing light and/or flickering). In some embodiments, the intermittent output of light includes encoded information that allows the first computer system to establish the second communication channel. In some embodiments, the intermittent output of light includes identification and/or credentials needed to establish a secure communication protocol with the second computer system.

In some embodiments, the information encoded in the first pattern of light is a code (e.g., as discussed above with respect to 410 and 412 in FIG. 4) (and/or authentication information) encoded in the light corresponding to the second computer system. In some embodiments, the first pattern of light is outputted by the second computer system at a certain frequency, and the frequency of output corresponds to the code. In some embodiments, the code is a setup code that includes an identification of the second computer system and verifiable information that the first computer system can check to determine whether to connect via the second communication channel (e.g., information as to the authenticity of the second computer system and/or information on validity and/or capabilities of the second computer system). In some embodiments, the code is a pairing code (e.g., an authentication code, an identification code, a device code, and/or an accessory setup code) to add the second computer system to a network of devices (e.g., enabling communication across the second communication channel and/or a home network) and/or to initiate a secure pairing process between the first computer system and the second computer system.

In some embodiments, while connected to the second computer system via the first communication channel, receiving, from the second computer system, a code (and/or authentication information) transferred via the first communication channel (e.g., as discussed above with respect to 408, 412, and 414 in FIG. 4). In some embodiments, connecting, via the second communication channel, to the second computer system includes using the code transferred via the first communication channel. In some embodiments, the first computer system uses the code transferred via the first communication channel and/or the code encoded in the light corresponding to the second computer system to establish the second communication channel. In some embodiments, the first computer system uses the code transferred via the first communication channel to confirm and/or validate the code encoded in the light corresponding to the second computer system (e.g., connecting via the second communication channel requires both and/or a validated code).

In some embodiments, the one or more input devices includes a flicker sensor (e.g., as discussed above with respect to 412 in FIG. 4). In some embodiments, the light corresponding to the second computer system is detected via the flicker sensor. In some embodiments, a flicker sensor is a light sensor (e.g., photo diode) configured to detect patterns of light, changes in light, and/or frequency of light (e.g., frequency of a light emitting device and/or display). In some embodiments, the flicker sensor detects light across various frequencies of light and/or rates of light output (e.g., adjusting which frequency and/or band of light to detect and/or alter detection rate to match different output rates by different devices).

In some embodiments, the one or more input devices includes one or more cameras (e.g., as discussed above with respect to FIG. 3A). In some embodiments, the light corresponding to the second computer system is detected via the one or more cameras (e.g., as discussed above with respect to FIGS. 3B and 3C and/or 412 in FIG. 4). In some embodiments, the one or more cameras detect light at a certain framerate. In some embodiments, the one or more cameras can alter a corresponding framerate to optimize the detection of light corresponding to the second computer system. In some embodiments, the one or more cameras filter captured images and/or video for changes in light to detect the light corresponding to the second computer system.

In some embodiments, the one or more input devices includes one or more cameras (e.g., as discussed above with respect to FIG. 3A). In some embodiments, before sending the request for the second computer system to output light, the first computer system detects, via the one or more cameras, the second computer system in a field of view of the one or more cameras (e.g., 310 and/or as discussed above with respect to 404 in FIG. 4). In some embodiments, the field of view is a first field of view. In some embodiments, the second computer system is not proximate enough to the first computer system to detect light. In some embodiments, the first computer system prompts for movement closer to the second computer system, to have a second field of view. In some embodiments, the first computer system waits to send a request to the second computer system until the second computer system fills and/or is positioned correctly within the field of view. In some embodiments, in response to detecting the second computer system in the field of view of the one or more cameras, the first computer system sends, via the first communication channel, a request for the second computer system to output light (e.g., as discussed above with respect to 408 in FIG. 4). In some embodiments, in response to detecting the second computer system in the field of view of the one or more cameras, in accordance with a determination that the second computer system is within a predefined portion of the field of view (and/or the second computer system takes up a predefined portion of the field of view), the first computer system sends the request for the second computer system to output light. In some embodiments, in response to detecting the second computer system in the field of view of the one or more cameras, in accordance with a determination that the second computer system is not within the predefined portion of the field of view (and/or the second computer system does not take up a predefined portion of the field of view), the first computer system forgoes sending the request for the second computer system to output light.

In some embodiments, after connecting to the second computer system using the information encoded in the first pattern of light, the first computer system registers, via the second communication channel, the second computer system within an ecosystem of computer systems (e.g., as discussed above in FIG. 3D and/or to 414 in FIG. 4). In some embodiments, the ecosystem of computer systems is a home network (e.g., a Wi-Fi network and/or secure network consisting of a plurality of connected devices). In some embodiments, the ecosystem of computer systems is a mesh network of accessory devices (e.g., a smart home and/or home management network consisting of smart devices such as network connected lights, cameras, and/or network management devices).

In some embodiments, registering the second computer system within the ecosystem of computer systems includes defining (e.g., assigning and/or saving), via the ecosystem of computer systems, a location within an environment (e.g., as discussed above to FIG. 3D and/or to 414 in FIG. 4) corresponding to the second computer system. In some embodiments, the location within the environment corresponds to a predefined zone within the environment (e.g., a kitchen, a living room, and/or a bedroom within a home). In some embodiments, defining the location within the environment includes instantiating a new location to assign the second computer system and/or other computer systems, and/or assigning the second computer system to an existing location within the environment (e.g., a location within the environment that already includes one or more other computer systems and/or devices).

In some embodiments, registering the second computer system within the ecosystem of computer systems includes assigning, via the ecosystem of computer systems, the second computer system to an automation (e.g., as discussed above in FIG. 3D and/or to 414 in FIG. 4) (e.g., to be carried out by the second computer system). In some embodiments, the automation is a series of actions performed by a particular computer system and/or device within the ecosystem of computer systems. In some embodiments, the automation is started and/or caused by an event and/or predefined guidelines (e.g., turn on at a certain time each day and/or send message due to detecting a trigger within the environment). In some embodiments, the automation is facilitated by the first computer system and carried out by the second computer system and/or one or more other devices. In some embodiments, the automation is managed and carried out by the second computer system and/or one or more other devices.

In some embodiments, the second computer system is an accessory device (e.g., as discussed above with respect to FIG. 3A). In some embodiments, the accessory device is a network connected device managed by another computer system and/or accessory management device. In some embodiments, the accessory device carries out one or more actions within an environment on behalf of another computer system in response to a request (e.g., a light accessory device turning on a room light due to a request from the first computer system and/or a lock accessory device unlocking a door due to a request form the first computer system).

In some embodiments, before (and/or while) sending the request for the second computer system to output light, the second computer system is not outputting light (e.g., as discussed above with respect to FIG. 3B and/or to 408 in FIG. 4). In some embodiments, the second computer system does not output light before receiving, via the first communication channel, from the first computer system the request to output light. In some embodiments, the second computer system waits for a request to output light and/or remains in an idle state until the second computer system receives a request.

In some embodiments, before sending the request for the second computer system to output light, the first computer system detects, via the one or more input devices, a current context (e.g., one or more characteristics and/or one or more attributes) of an environment (e.g., as discussed above with respect to 316 and/or to 410 in FIG. 4). In some embodiments, in response to detecting the current context of the environment, in accordance with a determination that the current context of the environment satisfies a first set of one or more criteria, the first computer system sends, via the first communication channel, a request to the second computer system to output a first type of light (e.g., as discussed above with respect to 408 in FIG. 4) (e.g., IR light and/or non-visible light). In some embodiments, the first set of one or more criteria includes a criterion that is based on a current light level of the environment. In some embodiments, the first set of one or more criteria includes a criterion that is based on presence of other sources of light (e.g., conflicting light from the sun, other light emitting devices, and/or displays). In some embodiments, the first set of one or more criteria is satisfied when visible light could not be detected by other devices and/or would be non-optimal to use based on the current context (e.g., requesting non-visible light at night to not wake or distract a subject within the environment and/or requesting IR light when a room is too bright for the first computer system to be able to discern different visible light sources). In some embodiments, in response to detecting the current context of the environment, in accordance with a determination that the current context of the environment satisfies a second set of one or more criteria, the first computer system sends, via the first communication channel, a request to the second computer system to output a second type of light (e.g., as discussed above with respect to 408 in FIG. 4) (e.g., visible light and/or alternative light), wherein the second type of light is different from the first type of light, and wherein the second set of one or more criteria is different from the first set of one or more criteria. In some embodiments, the second set of one or more criteria is satisfied when visible light would be the optimal light for the current context (e.g., competing IR signals within the environment from other devices).

In some embodiments, before sending the request for the second computer system to output light, the first computer system detects, via the one or more input devices, an input (e.g., 305a) (e.g., a tap input and/or voice input) corresponding to (e.g., directed to and/or associated with) a request to setup the second computer system (e.g., as discussed above with respect to FIG. 3A and/or to 402 in FIG. 4). In some embodiments, the input corresponding to the request to setup the second computer system is an input initiating a setup process and/or pairing process for the second computer system. In some embodiments, the setup process is a series of steps for adding the second computer system to an ecosystem of devices and/or to a network of devices. In some embodiments, the setup process includes assigning an identifier to the second computer system, assigning a location to the second computer system, and/or assigning the second computer system to an automation (e.g., triggered by another device and/or the second computer system) and/or action to be carried out by the second computer system. In some embodiments, in response to detecting the input corresponding to the request to setup the second computer system, the first computer system sends, via the first communication channel, the request for the second computer system to output light. In some embodiments, after detecting the light output from the second computer system, the first computer system adds, via the second communication channel, the second computer system to a network of devices and/or ecosystem of devices.

In some embodiments, connecting, via the first communication channel, to the second computer system includes initiating a pairing process (e.g., as discussed above with respect to FIG. 3A and/or to 402 in FIG. 4). In some embodiments, the pairing process is a series of steps for registering and/or adding the second computer system to an ecosystem of devices and/or a secure network (e.g., a home network and/or mesh network of other devices). In some embodiments, the pairing process provides other devices on a network information about the second computer system for future communication (e.g., forwarding requests between a mesh network of devices, completing actions on behalf of the network of devices, and/or performing one or more actions as part of automations instantiated by the ecosystem of devices).

In some embodiments, process 500 (FIG. 5) is performed at a first computer system (as described herein) via a system process (e.g., an operating system process and/or a server system process) that is different from one or more applications executing and/or installed on the first computer system.

In some embodiments, process 500 (FIG. 5) is performed at a first computer system (as described herein) by an application that is different from a system process.

In some embodiments, the instructions of the application, when executed, control the first computer system to perform process 500 (FIG. 5) by calling an application programming interface (API) provided by the system process. In some embodiments, the application performs at least a portion of process 500 (FIG. 5) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform process 500 (FIG. 5) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform process 500 (FIG. 5) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to process 500 (FIG. 5).

In some embodiments, API 176 defines a first API call response that can be provided to an application by API calling instructions 174, wherein the first API call response includes parameters described above with respect to process 500 (FIG. 5).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve how a user pairs an accessory device. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a user pairs an accessory device. Accordingly, use of such personal information data enables better user experiences. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, configuration information for a newly added accessory device can be inferred based on non-personal information or a bare minimum amount of personal information, such as the accessory device being added by the device associated with the user or the accessory device being connected to additional devices not associated with the user.

What is claimed is:

1. A method, comprising:
at a first computer system that is in communication with one or more input devices:
sending, via a first communication channel, a request for a second computer system to output light, wherein the second computer system is external to the first computer system;
after sending the request for the second computer system to output light, detecting, via the one or more input devices, light corresponding to the second computer system; and
in response to detecting the light corresponding to the second computer system:
in accordance with a determination that the light has a first pattern of light, connecting, via a second communication channel separate from the first communication channel, to the second computer system using information encoded in the first pattern of light; and
in accordance with a determination that the light has a second pattern of light, connecting, via the second communication channel, to the second computer system using information encoded in the second pattern of light.

2. The method of claim 1, wherein the first communication channel is an unsecure communication channel, and wherein the second communication channel is a secure communication channel.

3. The method of claim 2, wherein the unsecure communication channel is a Bluetooth connection, and wherein the secure communication channel is a Wi-Fi connection or a Thread connection.

4. The method of claim 1, further comprising:
after sending the request for the second computer system to output light, disconnecting, via the first communication channel, from the second computer system without detecting, via the one or more input devices, an input corresponding to a request to disconnect from the first communication channel.

5. The method of claim 4, further comprising:
in response to connecting, via the second communication channel, to the second computer system using information encoded in the first pattern of light, disconnecting, via the first communication channel, from the second computer system.

6. The method of claim 1, wherein the light is infrared light.

7. The method of claim 1, wherein the light is visible light.

8. The method of claim 1, wherein detecting the light corresponding to the second computer system includes detecting, via the one or more input devices, an intermittent output of light corresponding to the second computer system, and wherein the first pattern of light is identified in the intermittent output of light.

9. The method of claim 1, wherein the information encoded in the first pattern of light is a code encoded in the light corresponding to the second computer system.

10. The method of claim 9, wherein, while connected to the second computer system via the first communication channel, receiving, from the second computer system, a code transferred via the first communication channel, and wherein connecting, via the second communication channel, to the second computer system includes using the code transferred via the first communication channel.

11. The method of claim 1, wherein the one or more input devices includes a flicker sensor, and wherein the light corresponding to the second computer system is detected via the flicker sensor.

12. The method of claim 1, wherein the one or more input devices includes one or more cameras, and wherein the light corresponding to the second computer system is detected via the one or more cameras.

13. The method of claim 1, wherein the one or more input devices includes one or more cameras, the method further comprising:
before sending the request for the second computer system to output light, detecting, via the one or more cameras, the second computer system in a field of view of the one or more cameras; and
in response to detecting the second computer system in the field of view of the one or more cameras, sending, via the first communication channel, a request for the second computer system to output light.

14. The method of claim 1, further comprising:
after connecting to the second computer system using the information encoded in the first pattern of light, registering, via the second communication channel, the second computer system within an ecosystem of computer systems.

15. The method of claim 14, wherein registering the second computer system within the ecosystem of computer systems includes defining, via the ecosystem of computer systems, a location within an environment corresponding to the second computer system.

16. The method of claim 1, wherein registering the second computer system within the ecosystem of computer systems includes assigning, via the ecosystem of computer systems, the second computer system to an automation.

17. The method of claim 1, wherein the second computer system is an accessory device.

18. The method of claim 1, wherein, before sending the request for the second computer system to output light, the second computer system is not outputting light.

19. The method of claim 1, further comprising:
before sending the request for the second computer system to output light, detecting, via the one or more input devices, a current context of an environment; and
in response to detecting the current context of the environment:
in accordance with a determination that the current context of the environment satisfies a first set of one or more criteria, sending, via the first communication channel, a request to the second computer system to output a first type of light; and
in accordance with a determination that the current context of the environment satisfies a second set of one or more criteria, sending, via the first communication channel, a request to the second computer system to output a second type of light, wherein the second type of light is different from the first type of light, and wherein the second set of one or more criteria is different from the first set of one or more criteria.

20. The method of claim 1, further comprising:
before sending the request for the second computer system to output light, detecting, via the one or more input devices, an input corresponding to a request to setup the second computer system; and
in response to detecting the input corresponding to the request to setup the second computer system, sending, via the first communication channel, the request for the second computer system to output light.

21. The method of claim 1, wherein connecting, via the first communication channel, to the second computer system includes initiating a pairing process.

22. A non-transitory computer-readable storage medium storing one or more programs configured to be executed by one or more processors of a first computer system that is in communication with one or more input devices, the one or more programs including instructions for:
sending, via a first communication channel, a request for a second computer system to output light, wherein the second computer system is external to the first computer system;
after sending the request for the second computer system to output light, detecting, via the one or more input devices, light corresponding to the second computer system; and
in response to detecting the light corresponding to the second computer system:
in accordance with a determination that the light has a first pattern of light, connecting, via a second communication channel separate from the first communication channel, to the second computer system using information encoded in the first pattern of light; and
in accordance with a determination that the light has a second pattern of light, connecting, via the second communication channel, to the second computer system using information encoded in the second pattern of light.

23. A first computer system configured to communicate with one or more input devices, the first computer system comprising:
one or more processors; and
memory storing one or more programs configured to be executed by the one or more processors, the one or more programs including instructions for:
sending, via a first communication channel, a request for a second computer system to output light, wherein the second computer system is external to the first computer system;
after sending the request for the second computer system to output light, detecting, via the one or more input devices, light corresponding to the second computer system; and
in response to detecting the light corresponding to the second computer system:
in accordance with a determination that the light has a first pattern of light, connecting, via a second communication channel separate from the first communication channel, to the second computer system using information encoded in the first pattern of light; and
in accordance with a determination that the light has a second pattern of light, connecting, via the second communication channel, to the second computer system using information encoded in the second pattern of light.
